(19) United States
(12) Patent Application Publication
(10) Pub. No.: US 2026/0134879 A1
(43) Pub. Date: May 14, 2026

(54) SMART MICROPHONE TO IMPROVE DETECTION OF SPEAKER

(71) Applicant: Sony Interactive Entertainment Inc., Tokyo (JP)

(72) Inventor: Oliver Capio, San Mateo, CA (US)

(21) Appl. No.: 18/946,028

(22) Filed: Nov. 13, 2024

(51) Int. Cl. G10L 21/0316; G10L 17/04; G10L 17/18; H04R 1/04; H04R 1/08

(52) U.S. Cl. CPC G10L 21/0316; G10L 17/04; G10L 17/18; H04R 1/04; H04R 1/08

(57) ABSTRACT

Techniques are provided to improve the detection of a person speaking and to boost and amplify sound to avoid encouraging people in a group individually grabbing the microphone and putting it close to their face to speak. The position of the microphone is used to amplify audio, and noise cancellation may be employed.

### FIELD

The present application relates generally to smart microphones to improve detection of speakers.

### BACKGROUND

During video games and other activities, multiple people may speak using the aid of one or more microphones. The speech may define game chat, for example, or simply information intended for a group of listeners.

### SUMMARY

An apparatus includes at least one processor system configured to receive indication from at least one microphone of input energy. The input energy is of speech picked up by the microphone. The processor system is configured to adjust a gain of the input energy to produce an output energy of the microphone that has an amplitude at least as great as a predetermined amplitude.

In some embodiments the processor system is configured to adjust the gain of the input energy to produce an output energy of the microphone that has an amplitude within a predetermined band of amplitudes.

In example implementations the processor system can be configured to receive indication of an orientation of the microphone, and use the indication of an orientation of the microphone to adjust the gain of the input energy.

In one example, the processor system can be configured to, in a first step, correlate the orientation of the microphone to a first gain adjustment factor to render an orientation-based gain adjusted signal, and in a second step normalize the orientation-based gain adjusted signal to be a desired amplitude and/or to be within a band of desired amplitudes. In another example, the processor system may be configured to input to a machine learning (ML) both the orientation and input energy and adjust the gain according to output of the ML model. The ML model can be trained on data that includes pairs of orientation and input energy along with ground truth gain.

The processor system can be, e.g., in the microphone or a computer game console.

In non-limiting implementations, the processor system can be configured to adjust a gain of all frequencies of the input energy to produce the output energy. In other implementations the processor system is configured to adjust a gain of at least one frequency but not all frequencies of the input energy to produce the output energy.

In another aspect, an apparatus includes at least one processor system configured to receive indication of an orientation of a microphone, and use the indication of an orientation of the microphone to adjust a gain of input energy to the microphone.

In another aspect, an apparatus includes at least one processor system configured to execute A or B or A and B together. “A” includes steering a beam of a microphone toward a first source of sound responsive to the first source of sound having a target frequency with a higher amplitude than the target frequency from a second source of sound. On the other hand, “B” includes receiving speech at a microphone and determining a gain to apply to an input energy of the microphone based on an identity of a speaker of the speech.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example microphone system consistent with present principles;

FIG. 3 illustrates an example microphone consistent with present principles;

FIG. 4 illustrates an alternate example microphone system consistent with present principles;

FIG. 5 illustrates example logic in example flow chart format;

FIG. 6 illustrates alternate example logic in example flow chart format;

FIG. 7 illustrates yet another alternate example logic in example flow chart format;

FIG. 8 illustrates example ML training logic in example flow chart format;

FIG. 9 illustrates an example graph of varying gain to remain within a desired output band; and

FIG. 10 illustrates an example graph of varying gain on a frequency band by frequency band basis.

### DETAILED DESCRIPTION

This disclosure relates generally to computer ecosystems including aspects of consumer electronics (CE) device networks such as but not limited to computer game networks. A system herein may include server and client components
which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

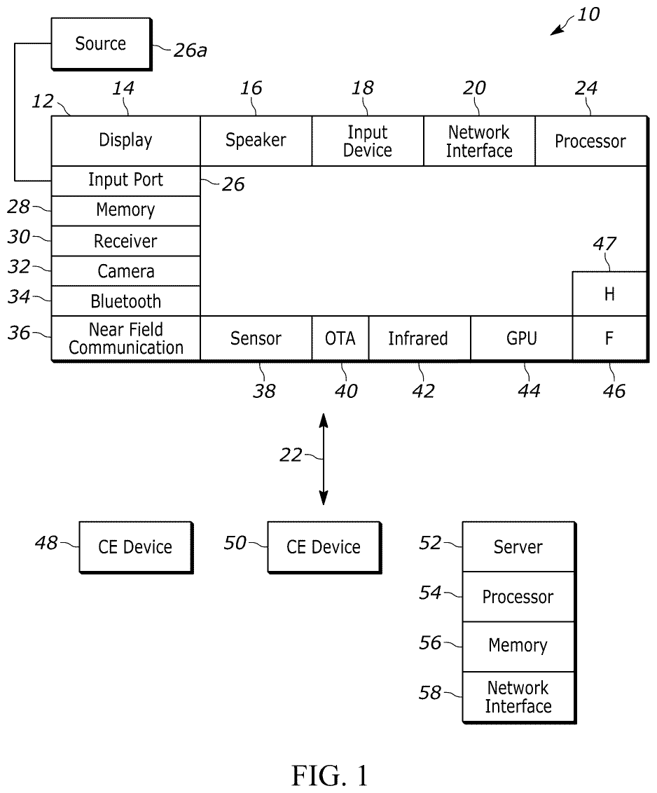

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth^{®}transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

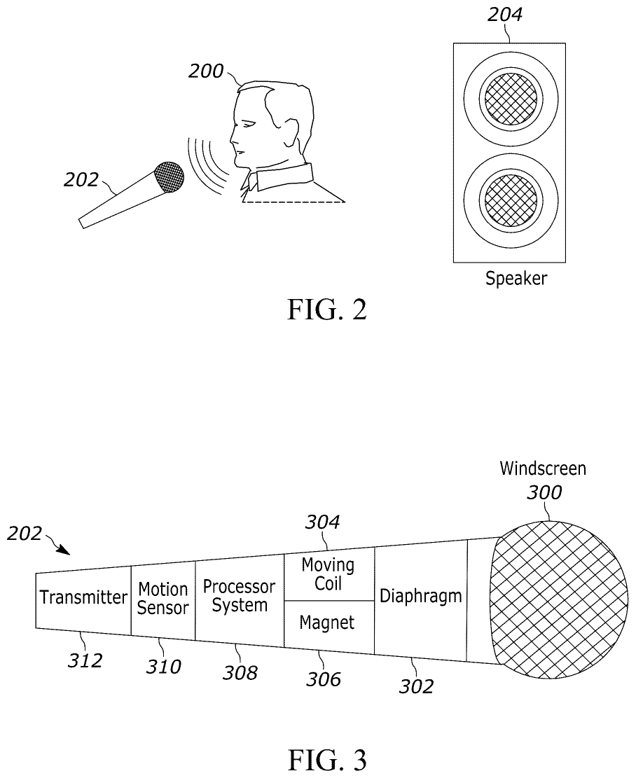

Refer now to FIG. 2. A person 200 may speak into a microphone 202 and the speech picked up by the microphone is played on one or more speakers 204.

FIG. 3 illustrates that the example microphone 202 may include, at the end that is typically closest to the person's mouth, a windscreen cover 300. The person's voice is picked by a combination of a diaphragm 302, moving coil 304, and magnet 306. A processor system 308 accessing instructions on computer memory can process the input signal as set forth further below, it being understood that the processing alternatively may be implemented by another processor system such as a processor in the speaker 204 or other component. The microphone 202 also may include a motion sensor 310 such as an inertial measurement unit (IMU) and/or gyroscope to output a signal representative of the orientation of the microphone. Signals from the microphone may be sent to other components such as the speaker 204 via a wired or wireless transmitter 312.

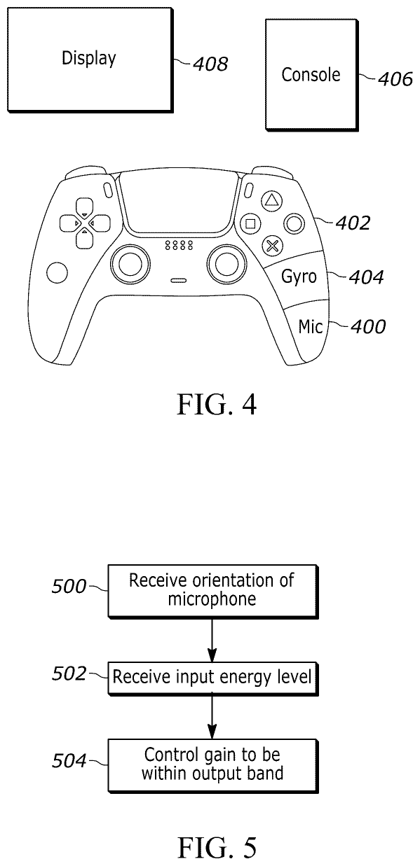

FIG. 4 shows that alternative to a standalone microphone, a microphone 400 may be implemented on a computer game controller 402 along with a motion sensor 404 such as a gyroscope. The controller 402 may be used by a gamer to play a game sourced from a computer game console 406 for presentation on a display 408. Speech picked up from the microphone 400 may be used in game chat, for example.

FIG. 5 illustrates a first technique to improve the detection of a person speaking and to boost and amplify sound to avoid encouraging people in a group individually grabbing the microphone and putting it close to their face to speak. The position of the microphone may be used to amplify audio, and noise cancellation may be employed. This technique recognizes that some people may speak with loud voices, others may be soft-spoken, some may hold the microphone close to the mouth, others may wave or hold the microphone at a distance from their mouth. Present techniques normalize input energy (as received by the microphone) to achieve a constant output energy (from the microphone or as played on a speaker) or constant output energy band.

Commencing at state 500 in FIG. 5, signals from any motion sensor described herein that indicate the orientation of the microphone are received and the orientation of the microphone indicated thereby. Moving to state 502, the input energy of the voice picked up by the microphone is determined, and at state 504 the output gain of the microphone is controlled to be a desired amplitude or within a desired band of amplitudes based on the microphone orientation and input energy.

In one embodiment, the process of FIG. 5 may be performed in discrete steps. In an initial step the orientation of the microphone is correlated to a first gain adjustment factor. For example, if the microphone is being held upside-down, more gain may be applied to the input signal because the microphone likely is pointed away from the person's mouth, whereas if the microphone orientation is upright and slightly tilted, it can be inferred that the person is holding the microphone directly in front of his mouth and hence smaller or no additional gain need be applied in the initial stage.

In a second step the orientation-based gain adjusted signal is then normalized to be a desired amplitude and/or to be within a band of desired amplitudes.

In another technique, a machine learning (ML) model described further below receives as input both the orientation and input energy levels and outputs a gain-adjusted output signal.

In some embodiments only input energy is used and orientation is not used to produce a gain-adjusted output signal.

In some embodiments only microphone orientation is used and input energy is not used to produce a gain-adjusted output signal.

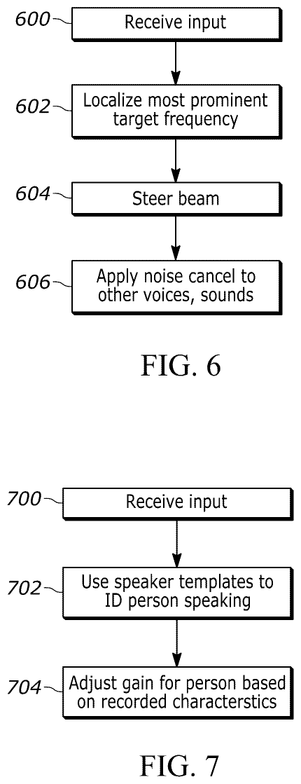

FIG. 6 illustrates an alternate technique. Commencing at state 600, the microphone input signal is received. Moving to state 602, a most prominent voiced target frequency is identified by localization. In such a case the microphone can be a directional microphone. An example voiced target frequency may be a voiced frequency in the bass range. Or, the target frequency may be a voiced frequency in the treble range.

Proceeding to state 604, the beam of the microphone is steered toward the most prominent target frequency. If desired, at state 606 noise cancelation may be applied to cancel out voiced input from sources other than the source of the most prominent target frequency and to also cancel other sounds such as ambient noise.

FIG. 7 illustrates yet another technique. Commencing at state 700, the microphone input signal is received. Moving to state 702, speaker templates are accessed to compare the acoustic signature of the voice picked up at state 700 to acoustic signatures of the templates. Each template may represent a person. The template that most closely matches the input identifies the person speaking. Each template may also include an indication of how much gain is to be applied to each particular person based on recorded characteristics of that person when speaking into a microphone. This is used to adjust the gain of the input signal at state 704.

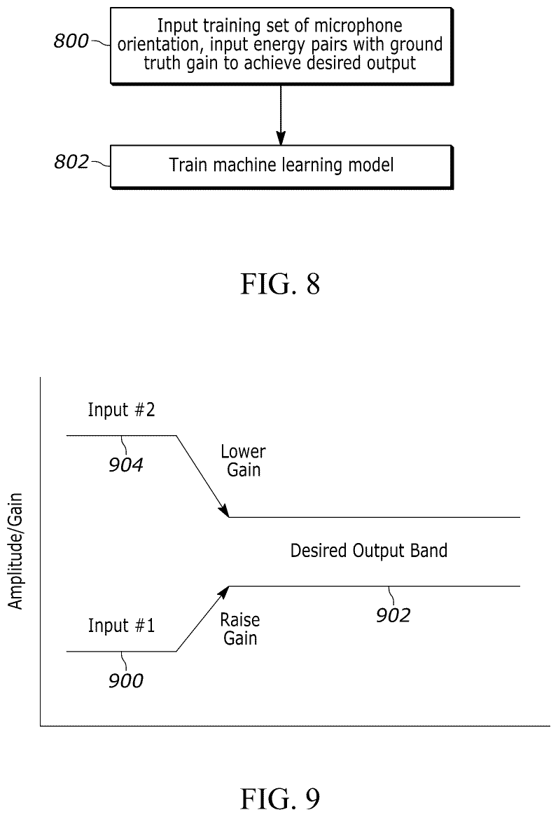

FIG. 8 illustrates logic that may be used to train a ML model to execute the logic of FIG. 3. Commencing at state 800 a training set of data is input to the ML model to train the model at state 802. The training set may include sample pairs of microphone orientation indications along with input energy indications and ground truth indication of gain to be applied to input signals corresponding to the corresponding pair to render a normalized output signal from the microphone.

FIG. 9 illustrates the above techniques in graphical form. A first input signal 900 at a relatively low amplitude has its gain increased to render an output signal in a desired band 902. On the other hand, a second input signal 904 at a relatively high amplitude has its gain decreased to render an output signal in the desired band 902. The first input signal may have its gain increased to be near the lower part of the desired output band 902. Or, the first input signal may have its gain increased to be near the higher part of the desired output band 902. The second input signal may have its gain decreased to be near the lower part of the desired output band 902. Or, the second input signal may have its gain decreased to be near the higher part of the desired output band 902. These are but a few examples of how present principles can adjust the gain of the input signal to achieve a constant output energy or band.

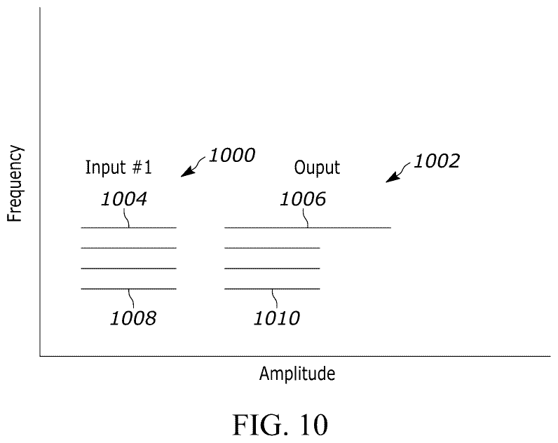

FIG. 10 graphically illustrates additional principles. In FIG. 10, and input signal 1000 has plural frequencies as shown. Gain is selectively applied on a frequency-by-frequency (or frequency band-by-frequency band) basis to produce an output signal 1002 whose frequency-dependent amplitudes are not the same profile as those of the input signal 1000. In the non-limiting illustrative embodiment shown, a first frequency 1004 of the input signal 1000 has been amplified to a higher amplitude as shown at 1006 in the output signal 1002, whereas a second frequency 1008 of the input signal 1000 has not been amplified and remains at the same amplitude as shown at 1010 in the output signal 1002. Accordingly, only lower frequencies of the input signal may have their gains adjusted up or down. Or, only higher frequencies of the input signal may have their gains adjusted up or down.

While the particular embodiments are herein shown and described in detail, it is to be understood that the subject matter which is encompassed by the present invention is limited only by the claims.

What is claimed is:

1. An apparatus comprising:
at least one processor system configured to:
receive indication from at least one microphone of input energy, the input energy being of speech picked up by the microphone; and
adjust a gain of the input energy to produce an output energy of the microphone that has an amplitude at least as great as a predetermined amplitude.

2. The apparatus of claim 1, wherein the processor system is configured to:
adjust the gain of the input energy to produce an output energy of the microphone that has an amplitude within a predetermined band of amplitudes.

3. The apparatus of claim 1, wherein the processor system is configured to:
receive indication of an orientation of the microphone; and
use the indication of an orientation of the microphone to adjust the gain of the input energy.

4. The apparatus of claim 3, wherein the processor system is configured to:
in a first step correlate the orientation of the microphone to a first gain adjustment factor to render an orientation-based gain adjusted signal; and
in a second step normalize the orientation-based gain adjusted signal to be a desired amplitude and/or to be within a band of desired amplitudes.

5. The apparatus of claim 3, wherein the processor system is configured to:
input to a machine learning (ML) both the orientation and input energy; and
adjust the gain according to output of the ML model.

6. The apparatus of claim 5, wherein the ML model is trained on data comprising pairs of orientation and input energy along with ground truth gain.

7. The apparatus of claim 1, wherein the processor system is in the microphone.

8. The apparatus of claim 1, wherein the processor system is in a computer game console.

9. The apparatus of claim 1, wherein the processor system is configured to:
adjust a gain of all frequencies of the input energy to produce the output energy.

10. The apparatus of claim 1, wherein the processor system is configured to:
adjust a gain of at least one frequency but not all frequencies of the input energy to produce the output energy.

11. An apparatus comprising:
at least one processor system configured to:
receive indication of an orientation of a microphone; and
use the indication of an orientation of the microphone to adjust a gain of input energy to the microphone.

12. The apparatus of claim 12, wherein the processor system is configured to:
adjust the gain of the input energy to produce an output energy of the microphone that has an amplitude within a predetermined band of amplitudes.

13. The apparatus of claim 11, wherein the processor system is configured to:
receive indication of the input energy, the input energy being of speech picked up by the microphone; and
adjust a gain of the input energy to produce an output energy of the microphone that has an amplitude at least as great as a predetermined amplitude.

14. The apparatus of claim 13, wherein the processor system is configured to:
in a first step correlate the orientation of the microphone to a first gain adjustment factor to render an orientation-based gain adjusted signal; and
in a second step normalize the orientation-based gain adjusted signal to be a desired amplitude and/or to be within a band of desired amplitudes.

15. The apparatus of claim 13, wherein the processor system is configured to:
input to a machine learning (ML) both the orientation and input energy; and
adjust the gain according to output of the ML model.

16. The apparatus of claim q5, wherein the ML model is trained on data comprising pairs of orientation and input energy along with ground truth gain.

17. The apparatus of claim 11, wherein the processor system is configured to:
adjust a gain of at least one frequency but not all frequencies of the input energy to produce the output energy

18. An apparatus comprising:
at least one processor system configured to execute A or B or A and B together, wherein:
A comprises: steering a beam of a microphone toward a first source of sound responsive to the first source of sound having a target frequency with a higher amplitude than the target frequency from a second source of sound; and
B comprises: receiving speech at a microphone and determining a gain to apply to an input energy of the microphone based on an identity of a speaker of the speech.

19. The apparatus of claim 18, wherein the processor system is configured to execute A.

20. The apparatus of claim 18, wherein the processor system is configured to execute B.
